(19) United States
(12) Patent Application Publication
(10) Pub. No.: US 2014/0376226 A1
(43) Pub. Date: Dec. 25, 2014

(54) LED LIGHT FOR A LIGHT BOX SIGN

(71) Applicant: ARTLED TECHNOLOGY CORP., New Taipei (TW)

(72) Inventors: Chia-Tsung TSAO, Taipei (TW); Chan-Ching LIN, New Taipei (TW)

(21) Appl. No.: 13/921,639

(22) Filed: Jun. 19, 2013

(51) Int. Cl. F21K 99/00; F21V 29/00; F21V 23/00

(52) U.S. Cl. CPC F21K 9/175; F21V 23/005; F21V 29/004
USPC 362/237; 362/311.02; 362/294

(57) ABSTRACT

A LED light has a main power wire and at least one light module mounted on the main power wire. The at least one light module has a base, a circuit board, at least one LED, a translucent panel and an engaging piece. The circuit board is mounted on a top of the base and a circuit mounted on the circuit board is electrically connected to the main power wire. The at least one LED is mounted on the circuit board. The translucent panel is mounted above the circuit board and has at least one lens corresponding to the at least one LED formed on the translucent panel. The engaging piece is mounted on a bottom of the base to allow a user to easily mount the LED light on a pole of a light box sign.

### BACKGROUND OF THE INVENTION

1. Field of the Invention

The present invention relates to an LED light and more particularly to an LED light adapted for a light box sign.

2. Description of Related Art

A light box sign is an advertising sign having illuminants inside the advertising sign. The light box sign glows in night such that people can see the light box sign clearly. A glowing light box sign attracts people's attention to promote business. A conventional light box sign has a translucent box and multiple fluorescent tubes mounted at intervals in the box. The fluorescent tubes are used as an illumination source to make the box glow.

However, the light box sign having an illumination source of the fluorescent tubes has the following defects:

1. The fluorescent tubes contain mercury, which has toxicity and is hazardous to people. Discarded fluorescent tubes are also hazardous to the environment. How to recycle and safely handle discarded fluorescent tubes is a problem still unresolved.

2. The fluorescent tubes are mounted at intervals in the box. Sections on a surface of the box directly facing the fluorescent tubes are brighter than other sections on the surface of the box, thus, the light box sign glows unevenly.

3. When mounting the fluorescent tube in the box, two connectors mounted on two ends of the fluorescent tube are inserted in two outlets that are mounted in the box, and then the fluorescent tube is rotated by 90 degrees to be positioned. The installation process requires two steps and is not so convenient.

### SUMMARY OF THE INVENTION

The main objective of the invention is to provide an LED light adapted for a light box sign. The LED light has a lens mounted above each LED of the LED light to make the LED light glow evenly.

The LED light comprises a main power wire and at least one light module mounted on the main power wire. The at least one light module has a base, a circuit board, at least one LED, a translucent panel and an engaging piece. The circuit board is mounted on a top of the base and a circuit mounted on the circuit board is electrically connected to the main power wire. The at least one LED is mounted on the circuit board. The translucent panel is mounted above the circuit board and has at least one lens formed on the translucent panel and corresponding to the at least one LED. The engaging piece is mounted on a bottom of the base.

The LED light in accordance with the present invention has the following advantages:

1. An LED (light emitting diode) has a high luminous efficiency and a long service life, and the LED contains no toxic substances such as mercury, thus, the LED is environmentally friendly.

2. A light emitted by the at least one LED is evenly scattered by the at least one lens such that the LED light can glow evenly.

3. The engaging piece is adapted for being directly mounted on a pole of a light box sign to position the LED light. The installation is simplified into a one-step process.

### BRIEF DESCRIPTION OF THE DRAWINGS

FIG. 1 is a perspective view of an LED light in accordance with the present invention;

FIG. 2 is an exploded view of the LED light in FIG. 1;

FIG. 3 is another exploded view of the LED light in FIG. 1;

FIG. 4 is a top view of the LED light in FIG. 1;

FIG. 5 shows the LED light in FIG. 1 mounted in a light box sign;

FIG. 6 is a side view of the LED light in FIG. 1;

FIG. 7 is an operational view of the LED light in FIG. 1, showing the LED light vertically mounted on a pole of a light box sign;

FIG. 8 is another operational view of the LED light in FIG. 1, showing the LED light horizontally mounted on a pole of a light box sign.

### DETAILED DESCRIPTION OF THE PREFERRED EMBODIMENTS

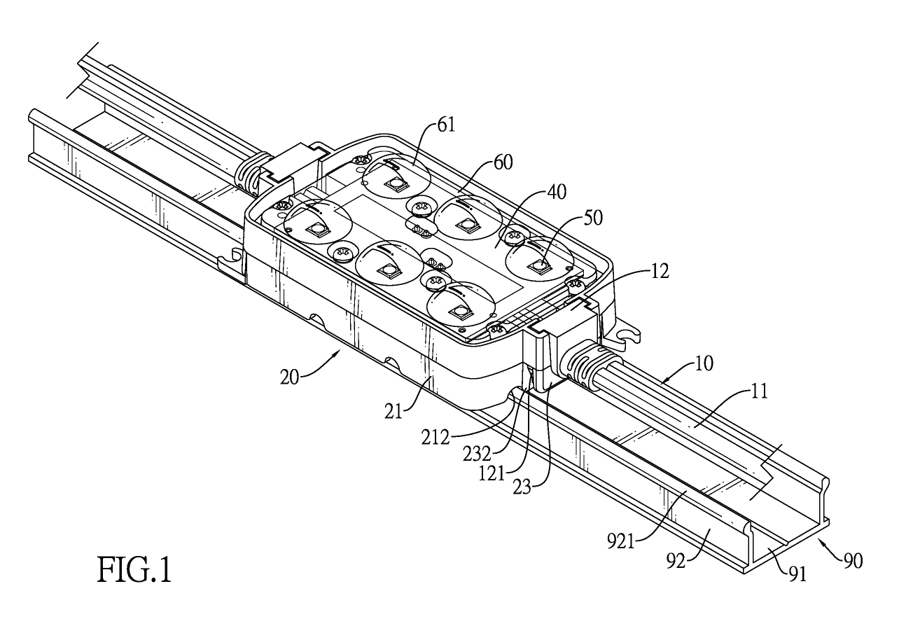

With reference to FIGS. 1 to 3, an LED light in accordance with the present invention comprises a main power wire 10 and at least one light module.

The main power wire 10 includes two power wires 11 and has at least one circuit element having a memory function and mounted on the power wires 11. In a preferred embodiment, the at least one circuit element is two RS flip-flops 12. Each RS flip-flop 12 has two buckles 121 respectively formed on two sides of a bottom of the RS flip-flop 12. Wire sheathing on a section of each power wire 11 between the RS flip-flops 12 is removed such that a bare wire section 111 is formed on each power wire 11. The two bare wire sections 111 of the power wires 11 do not contact each other.

A quantity of the at least one light module corresponds to a quantity of the at least one circuit element of the main power wire 10. The at least one light module has a base 20, two heat pads 30, a circuit board 40, at least one LED 50, a translucent panel 60 and an engaging piece 70.

The base 20 has a rectangular, annular sidewall 21, a rectangular loading part 22 and two positioning parts 23. The sidewall 21 includes two opposite short walls and two opposite long walls. The loading part 22 is mounted in a space surrounded by the sidewall 21 and has an elongated recess 221 concavely formed on a middle of a top of the loading part 22. A longitudinal direction of the elongated recess 221 is parallel to a longitudinal direction of the long walls of the sidewall 21, and two ends of the elongated recess 221 are open ends. Each short wall of the sidewall 21 has an opening 211 corresponding to one end of the elongated recess 221, and a top of the opening 211 is an open top. Each positioning part 23 corresponds to one of the openings 211, protrudes from an outer surface of the short wall having said corresponding opening 211, and has a positioning recess 231 and two buckle holes 232. The positioning recess 231 communicates with said corresponding opening 211. The positioning recess 231 has an open top. The two buckle holes 232 are respectively formed on two sides of a bottom of the positioning part 23 and communicate with the positioning recess 231. Each short wall of the sidewall 21 has two concave portions 212 formed at an interval on a bottom edge of the short wall. Each long wall of the sidewall 21 also has two concave portions 212 formed at an interval on a bottom edge of the long wall. The loading part 22 has four positioning poles 222 respectively protruding from four corners of the top of the loading part 22. The power wires 11 of the main power wire 10 are respectively mounted in the elongated recess 221 of the base 20. Each RS flip-flop 12 is mounted in the positioning recess 231 of a corresponding positioning part 23 of the base 20, and buckles 121 of the RS flip-flop 12 are respectively mounted in the buckle holes 232 of the corresponding positioning part 23 to fix the main power wire 10 on the base 20.

Each heat pad 30 has two first positioning holes 31 respectively formed through two ends of the heat pad 30. The heat pads 30 are mounted on the top of the loading part 22 of the base 20, and are respectively mounted on two sides of the main power wire 10 such that the four positioning poles 222 of the loading part 22 respectively penetrate through the first positioning holes 31 of the heat pads 30.

The circuit board 40 is rectangular, and has two pin holders 41 and an IC (integrated circuit) 42 mounted at intervals on a bottom of the circuit board 40. The pin holders 41 respectively have two metal pins 411. Four second positioning holes 43 are respectively formed through four corners of the circuit board 40. The circuit board 40 is mounted on the heat pads 30 and above the main power wire 10, the bottom of the circuit board 40 contacts tops of the heat pads 30, and two metal pins 411 of one of the pin holders 41 are welded to one of the bare wire sections 111 of the power wires 11, the other two metal pins 411 of the other pin holder 41 are welded to the other bare wire section 111, such that the main power wire 10 is electrically connected to a circuit of the circuit board 40. The positioning poles 222 of the loading part 22 of the base 20 respectively penetrate through the first positioning holes 31 of the heat pads 30, and then respectively penetrate through the second positioning holes 43 of the circuit board 40. Multiple self-tapping screws 80 sequentially penetrate through the circuit board 40 and the heat pads 30, and then are fixed on the top of the loading part 22 to position and fix the circuit board 40 and the heat pads 30 on the base 20.

The at least one LED 50 is mounted on a top of the circuit board 40. In a preferred embodiment as shown in FIG. 1, the LED light in accordance with the present invention comprises multiple LEDs 50 mounted at intervals on the top of the circuit board 40.

The translucent panel 60 is mounted above the circuit board 40 and has at least one lens 61 formed on the translucent panel 60. Multiple self-tapping screws 80A are screwed through an edge of the translucent panel 60 and are fixed on the top of the loading part 22 to fix the translucent panel 60 on the base 20. The at least one lens 61 corresponds to the at least one LED 50, and a light emitted by the at least one LED 50 is scattered by the translucent panel 60 such that the light is emitted evenly through the translucent panel 60. In a preferred embodiment as shown in FIG. 1, the translucent panel 60 has multiple lenses 61 formed on the translucent panel 60 and respectively corresponding to the multiple LEDs 50.

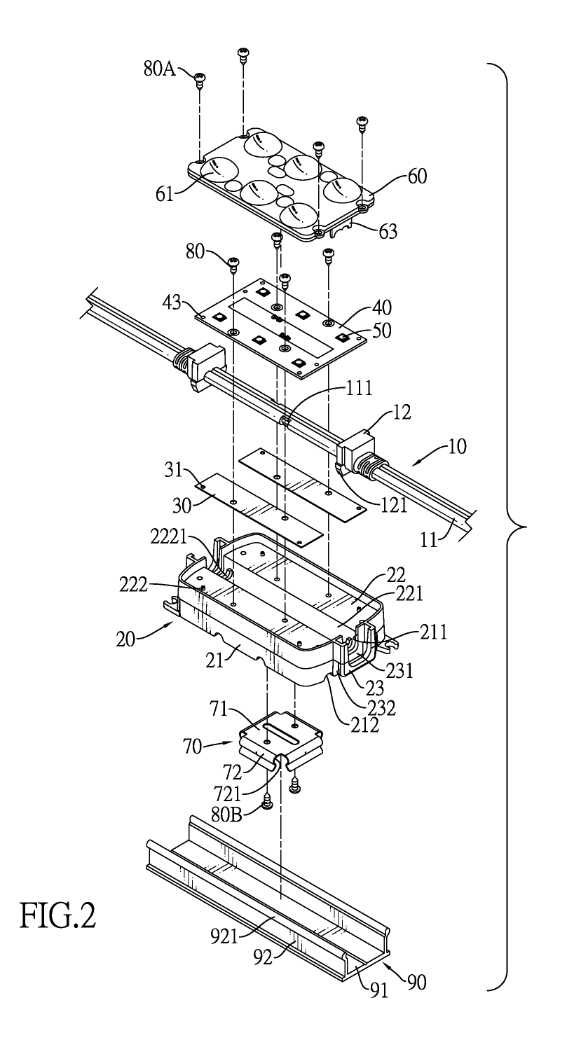

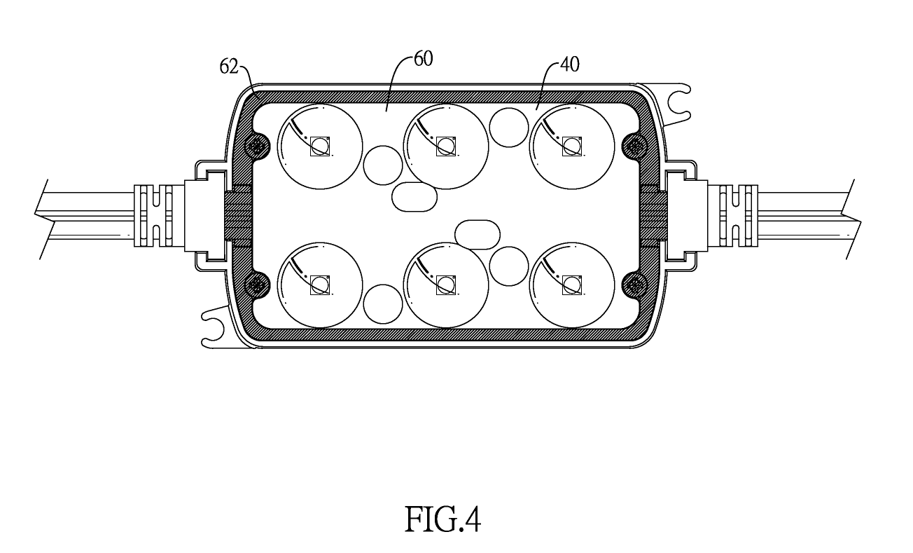

With reference to FIG. 4, the LED light further comprises a sealant 62 filled around the translucent panel 60 to seal the circuit board 40. With further reference to FIG. 2, the elongated recess 221 of the base 20 has two first splints 2221 respectively protruding from two ends of a recess surface of the elongated recess 221. The translucent panel 60 has two second splints 63 protruding from a bottom of the translucent panel 60 and respectively corresponding to the first splints 2221. The first splints 2221 and the second splints 63 can clip the power wires 11 of the main power wire 10 to prevent the sealant 62 from flowing in the elongated recess 221 and to decrease a usage amount of the sealant 62.

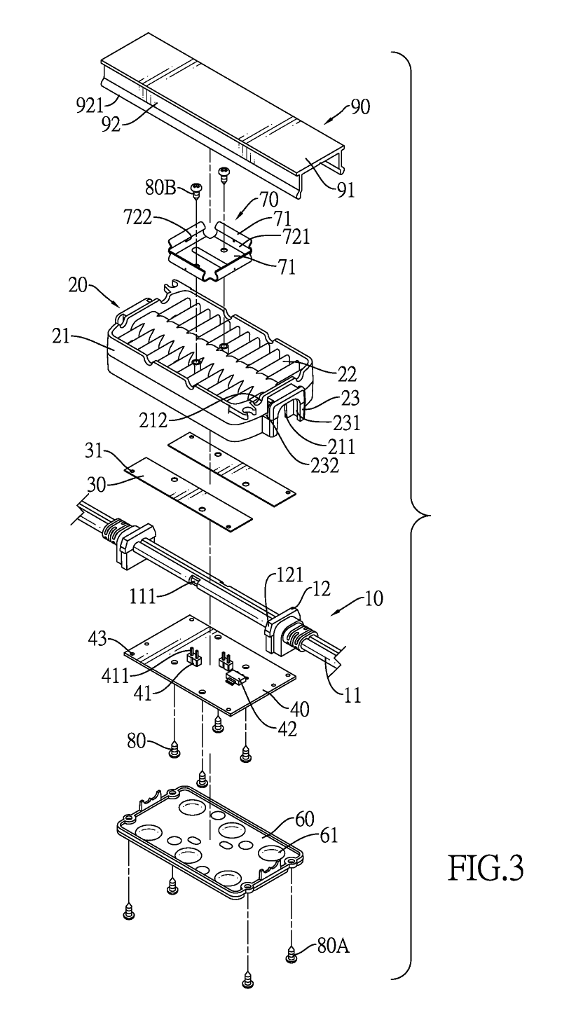

The engaging piece 70 has a square panel 71 and four engaging walls 72 respectively formed on four sides of the square panel 71. The engaging walls 72 are curved and each engaging wall 72 has a fixing recess 721. With further reference to FIG. 3, each engaging wall 72 has a convex tablet 722 protruding from a recess surface of the fixing recess 721. Multiple self-tapping screws 80B are screwed through the square panel 71 and are fixed on a bottom of the loading part 22 to fix the engaging piece 70 on the base 20.

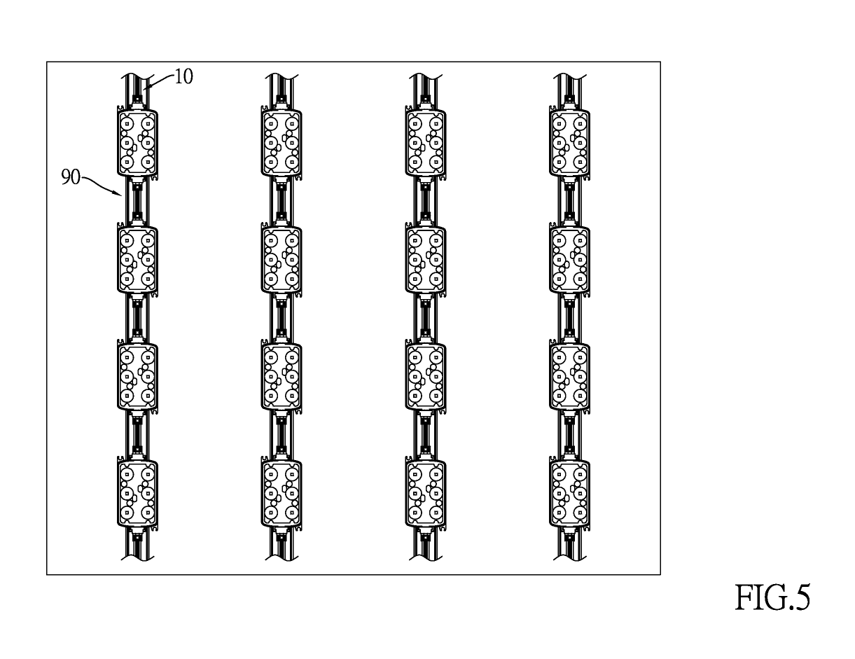

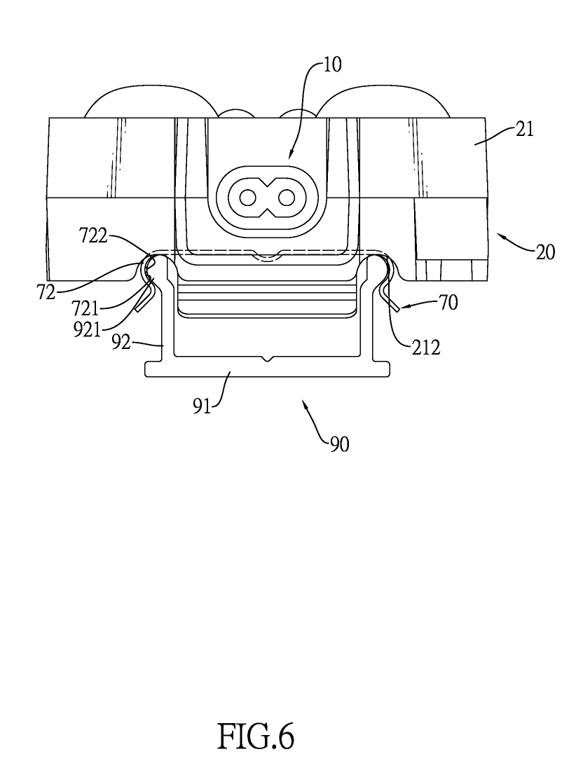

With reference to FIGS. 5 and 6, the LED light in accordance with the present invention is adapted for being mounted on a pole 90 of a light box sign. The pole 90 is formed by aluminum extrusion, and has an elongated panel 91 and two side panels 92 formed on two sides of the elongated panel 91. Each side panel 92 has a rib 921 formed on an end edge of the side panel 92. Two opposite engaging walls 72 of the engaging piece 70 are used to be mounted on outer surfaces of the side panels 92 of the pole 90, the ribs 921 are respectively mounted in the fixing recesses 721 of the engaging walls 72 and respectively correspond to the concave portions 212 of the side wall of the base 20, such that the LED light is mounted on the pole 90, and the convex tablets 722 abut the pole 90 to strengthen the engagement between the engaging piece 70 and the pole 90 to firmly mount the LED light on the pole 90.

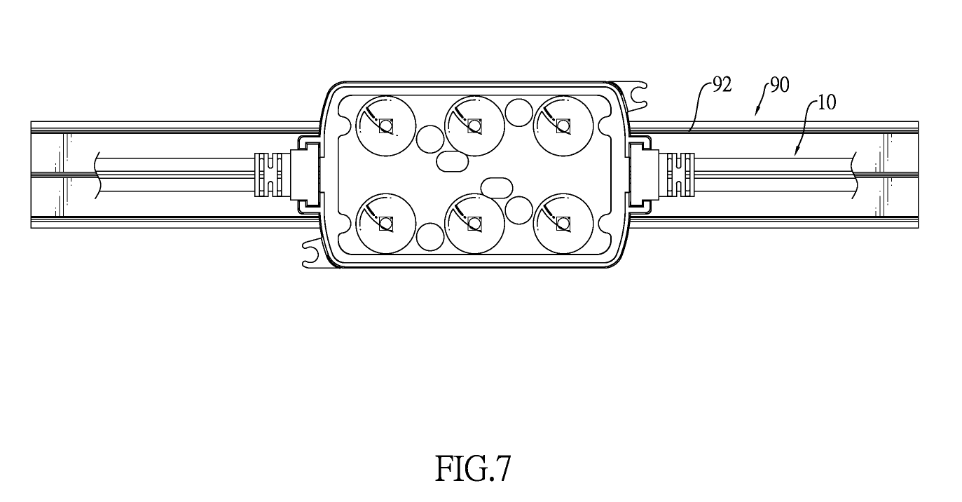

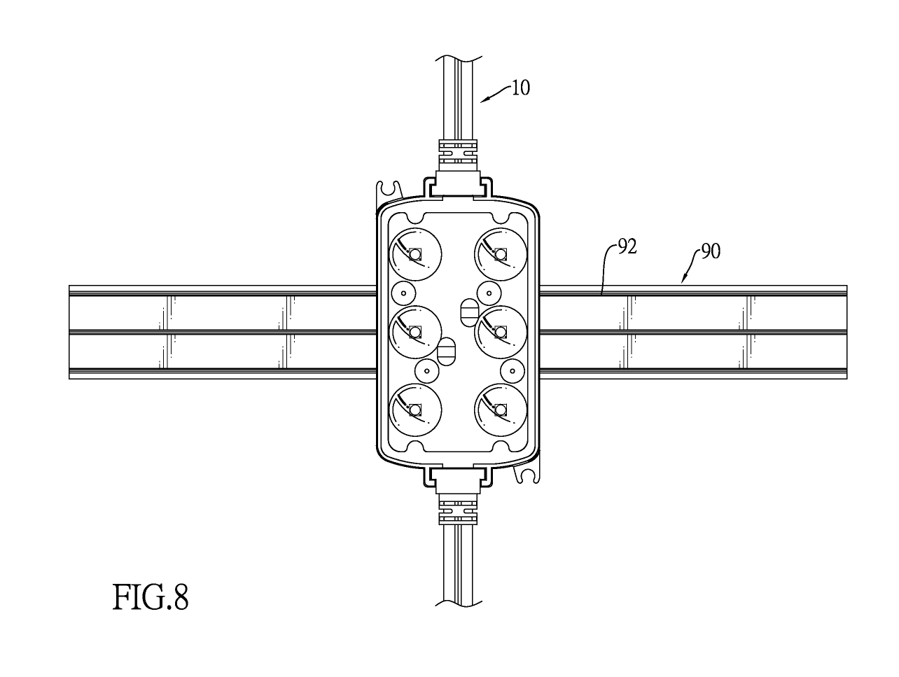

With reference to FIGS. 7 and 8, by two sets of the two opposite engaging walls 72 of the engaging piece 70 and the side panels 92 of the pole 90, the LED light in accordance with the present invention can be vertically or horizontally mounted on the pole 90 of the light box sign as desired.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An LED light adapted for a light box sign comprising:
a main power wire; and
at least one light module mounted on the main power wire and having
a base;
a circuit board mounted on a top of the base and having a circuit electrically connected to the main power wire;
at least one LED mounted on a top of the circuit board;
a translucent panel mounted above the circuit board and having at least one lens formed on the translucent panel, wherein the at least one lens corresponds to the at least one LED; and
an engaging piece mounted on a bottom of the base.

2. The LED light as claimed in claim 1, wherein
the main power wire includes two power wires and has
two RS flip-flops having a memory function, spaced apart from each other, and mounted on the power wires;
the base has
an annular side wall having two openings;
a loading part mounted in a space surrounded by the sidewall and having an elongated recess concavely formed on a middle of a top of the loading part, wherein two ends of the elongated recess are open ends and respectively correspond to the two openings of the side wall; and
two positioning parts, wherein each positioning part corresponds to one of the openings, protrudes from an outer surface of the annular side wall having said corresponding opening, and has a positioning recess, wherein the positioning recess communicates with said corresponding opening; and
wherein the main power wire is mounted in the elongated recess of the base; the RS flip-flops are respectively mounted in the positioning recesses of the positioning parts.

3. The LED light as claimed in claim 2, wherein each RS flip-flop has two buckles respectively formed on two sides of a bottom of the RS flip-flop; each positioning part has two buckle holes respectively formed on two sides of a bottom of the positioning part; the buckles of the RS flip-flops respectively correspond to the buckle holes of the positioning parts.

4. The LED light as claimed in claim 3, wherein
a wire sheathing on a section of each power wire between the RS flip-flops is removed such that a bare wire section is formed on each power wire, and the two bare wire sections of the power wires do not contact each other; and
the circuit board has two pin holders and an IC mounted at intervals on a bottom of the circuit board, wherein the pin holders are respectively welded to the bare wire sections of the power wires.

5. The LED light as claimed in claim 4, wherein the engaging piece has a square panel and four engaging walls respectively formed on four sides of the square panel, the engaging walls are curved, and each engaging wall has a fixing recess.

6. The LED light as claimed in claim 5, wherein each engaging wall has a convex tablet protruding from a recess surface of the fixing recess.

7. The LED light as claimed in claim 6, wherein
the elongated recess of the base has two first splints respectively protruding from two ends of a recess surface of the elongated recess; and
the translucent panel has two second splints protruding from a bottom of the translucent panel and respectively corresponding to the first splints, and the first splints and the second splints can clip the power wires of the main power wire.

8. The LED light as claimed in claim 2, wherein each one of the at least one light module further comprises two heat pads mounted on the top of the loading part of the base, and respectively mounted on two sides of the main power wire.

9. The LED light as claimed in claim 5, wherein each one of the at least one light module further comprises two heat pads mounted on the top of the loading part of the base, and respectively mounted on two sides of the main power wire.

10. The LED light as claimed in claim 7, wherein each one of the at least one light module further comprises two heat pads mounted on the top of the loading part of the base, and respectively mounted on two sides of the main power wire.

11. The LED light as claimed in claim 8, wherein
each heat pad has two first positioning holes respectively formed through two ends of the heat pad;
the circuit board is square and has four second positioning holes respectively formed through four corners of the circuit board; and
the loading part of the base is square and has four positioning poles respectively protruding from four corners of the loading part, wherein each positioning pole corresponds to one of the second positioning holes and one of the first positioning holes, and sequentially penetrates through said corresponding first positioning hole and said corresponding second positioning hole.

12. The LED light as claimed in claim 9, wherein
each heat pad has two first positioning holes respectively formed through two ends of the heat pad;
the circuit board is square and has four second positioning holes respectively formed through four corners of the circuit board; and
the loading part of the base is square and has four positioning poles respectively protruding from four corners of the loading part, wherein each positioning pole corresponds to one of the second positioning holes and one of the first positioning holes, and sequentially penetrates through said corresponding first positioning hole and said corresponding second positioning hole.

13. The LED light as claimed in claim 10, wherein
each heat pad has two first positioning holes respectively formed through two ends of the heat pad;
the circuit board is square and has four second positioning holes respectively formed through four corners of the circuit board; and
the loading part of the base is square and has four positioning poles respectively protruding from four corners of the loading part, wherein each positioning pole corresponds to one of the second positioning holes and one of the first positioning holes, and sequentially penetrates through said corresponding first positioning hole and said corresponding second positioning hole.

14. The LED light as claimed in claim 11, wherein
the at least one light module comprises multiple LEDs mounted at intervals on the top of the circuit board; and
the translucent panel has multiple lenses respectively corresponding to the LEDs.

15. The LED light as claimed in claim 12, wherein
the at least one light module comprises multiple LEDs mounted at intervals on the top of the circuit board; and
the translucent panel has multiple lenses respectively corresponding to the LEDs.

16. The LED light as claimed in claim 13, wherein
the at least one light module comprises multiple LEDs mounted at intervals on the top of the circuit board; and
the translucent panel has multiple lenses respectively corresponding to the LEDs.
